(19) United States
(12) Patent Application Publication
(10) Pub. No.: US 2006/0274641 A1
(43) Pub. Date: Dec. 7, 2006

(54) Method and apparatus for constant envelope orthogonal frequency division multiplexing in a wireless system

(75) Inventors: Donald M. Grieco, Manhassett, NY (US); Sung-Hyuk Shin, Northvale, NJ (US); Yingming Tsai, Boonton, NJ (US); Guodong Zhang, Farmingdale, NY (US); Prabhakar R. Chitrapu, Blue Bell, PA (US); Alain Charles Louis Briancon, Poolesville, MD (US); Paul Marinier, Brossard (CA); TieJun Shan, Upper Salford, PA (US); Yogendra Shah, Exton, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/394,931

(22) Filed: Mar. 31, 2006

Related U.S. Application Data
(60) Provisional application No. 60/668,434, filed on Apr. 4, 2005.
(60) Provisional application No. 60/668,253, filed on Apr. 4, 2005.

(51) Int. Cl. H04J 11/00

(52) U.S. Cl. 370/210

(57) ABSTRACT

In a wireless communication system comprising at least one wireless transmit/receive unit (WTRU), a base station, and a radio network controller (RNC), a method for constant envelope orthogonal frequency division multiplexing (CE-OFDM) modulation comprises the WTRU performing an inverse transform on the data. The WTRU next performs constant envelope (CE) modulation on the data and transmits the CE-OFDM data to the base station. The base station receives the data and CE demodulates the data. The base station performs a transform on the demodulated data.

### CROSS REFERENCED TO RELATED APPLICATIONS

This application claims the benefit of U.S. Provisional Application No. 60/668,434, filed on Apr. 4, 2005, and U.S. Provisional Application No. 60/668,253, filed on Apr. 4, 2005 which are incorporated by reference herein as if fully set forth.

### FIELD OF INVENTION

The present invention relates to wireless communications systems. More particularly, the present invention relates to a method and apparatus for constant envelope orthogonal frequency division multiplexing in a wireless system.

### BACKGROUND

Future wireless communication systems will provide broadband services such as wireless Internet access to subscribers. These broadband services require reliable and high-rate communications over time-dispersive channels (frequency-selective) channels with limited spectrum and inter-symbol interference (ISI) caused by multi-path fading.

One solution for this is to employ orthogonal frequency division multiplexing (OFDM). OFDM has high spectral efficiency since sub-carriers overlap in frequency and adaptive coding and modulation can be employed across the sub-carriers. Additionally, the baseband modulator and demodulator for OFDM need only be fast fourier transform (FFT) or inverse fast fourier transform (IFFT). OFDM also utilizes a simpler receiver and possesses excellent robustness in a multi-path environment.

OFDM has also been adopted by the following standards: Digital Audio Broadcast (DAB), Digital Video Broadcast Terrestrial (DVB-T), IEEE 802.11a/g, IEEE, and Asymmetric Digital Subscriber Line (ASDL). OFDM is also under consideration for the following standards: Wideband Code Division Multiple Access (WCDMA), CDMA2000, Fourth Generation (4G) wireless services, IEEE 802.11n, IEEE 802.16, and IEEE 802.20.

One disadvantage, however, of OFDM is its inherently high peak-to-average power ratio (PAPR). As the number of sub-carriers increases, the PAPR of OFDM increases. This causes severe signal distortion when high PAPR signals are transmitted through a non-linear power amplifier. Accordingly, highly linear power amplifiers with power backoff are required for OFDM. As a result, power efficiency and battery life are low in a wireless transmit/receive unit (WTRU) utilizing OFDM with a highly linear power amplifier.

Techniques have been extensively studied for reducing the PAPR of OFDM systems. These reduction techniques include coding, clipping, and filtering of the signal, among other techniques. Each one of these techniques varies in effectiveness and has its own inherent tradeoff in terms of complexity, performance, and spectral efficiency.

One potential solution for reducing the PAPR in an OFDM system is to utilize a constant envelope OFDM (CE-OFDM) system. Furthermore, by utilizing continuous phase modulation (CPM) in a CE-OFDM system, the PAPR (before pulse shape shifting such as RRC filtering) can be effectively reduced to 0 dB, allowing for the signal to be amplified with a power efficient non-linear power amplifier. Unfortunately, many key issues and tradeoffs of the CE-OFDM system have not been addressed.

There is a need, therefore, for a method and apparatus for transmitting and receiving data in a CE-OFDM system that is not subject to the limitations of the prior art.

### SUMMARY

In a wireless communication system comprising at least one wireless transmit/receive unit (WTRU), a base station, and a radio network controller (RNC), a method for constant envelope orthogonal frequency division multiplexing (CE-OFDM) modulation comprises the WTRU performing an inverse transform on the data. The WTRU next performs constant envelope (CE) modulation on the data and transmits the CE-OFDM data to the base station. The base station receives the data and CE demodulates the data. The base station performs a transform on the demodulated data.

### BRIEF DESCRIPTION OF THE DRAWINGS

The foregoing summary, as well as the following detailed description of the preferred embodiments of the present invention will be better understood when read with reference to the appended drawings, wherein:

FIG. 1 is a wireless communication system configured in accordance with the present invention.

FIG. 2 is a block diagram of a WTRU and Base Station of the wireless communication system of FIG. 1;

FIG. 3 is a flow diagram of a process for transmitting and receiving data in the wireless communication system of FIG. 1;

FIG. 4 is a functional block diagram of a transmitting WTRU employing clipping, in accordance with the present invention;

FIG. 5 is a functional block diagram of a transmitting WTRU and receiving base station employing quantization, in accordance with the present invention;

FIG. 6 is a functional block diagram of a transmitting WTRU and a receiving base station employing filtering, in accordance with the present invention;

FIG. 7 is a functional block diagram of a transmitting WTRU and receiving base station utilizing a cyclic prefix, in accordance with the present invention;

FIG. 8 is a functional block diagram of a transmitting WTRU employing an adaptive constant envelope orthogonal frequency division multiplexing (CE-OFDM) scheme in accordance with the present invention;

FIG. 9 is a functional block diagram depicting two stage equalization in the receiving base station, in accordance with the present invention;

FIG. 10 is a functional block diagram depicting an alternative two stage equalization in the receiving base station, in accordance with the present invention;

FIG. 11 is a functional block diagram of a transmitting WTRU and a receiving base station employing joint two-stage channel estimation with pre-equalization, in accordance with the present invention;

FIG. 12 is a functional block diagram of a transmitting WTRU and a receiving base station employing an alternative joint two-stage channel estimation, in accordance with the present invention;

FIG. 13 is a functional block diagram of a transmitting WTRU and a receiving base station employing turbo equalization, in accordance with the present invention;

FIG. 14 is a functional block diagram of a prior art transmitting WTRU and a receiving base station.

FIG. 15 is a functional block diagram of a transmitting WTRU and a receiving base station employing time and frequency synchronization, in accordance with the present invention;

FIG. 16 is a representation of a received signal without frequency offset; and

FIG. 17 is a representation of a received signal with frequency offset.

### DETAILED DESCRIPTION OF THE PREFERRED EMBODIMENTS

Hereafter, a mobile infinite storage device includes but is not limited to a user equipment, a wireless transmit/receive unit (WTRU), mobile station, fixed or mobile subscriber unit, pager, or any other type of device capable of operating in a wireless environment.

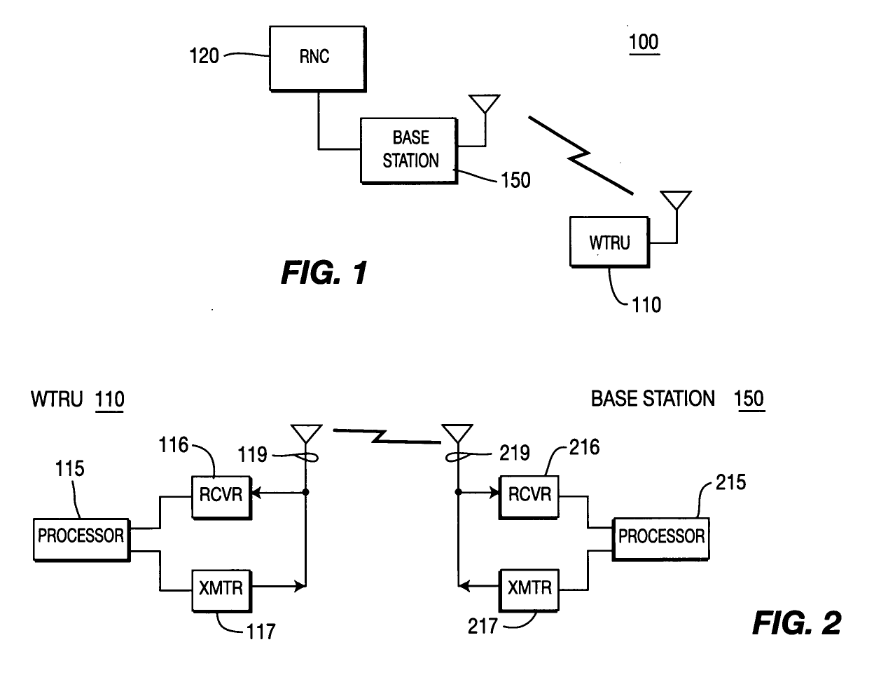

Referring now to the drawings, wherein like reference numerals refer to similar components across the several views, and in particular to FIG. 1, a wireless communication system 100 in accordance with the present invention is shown. The wireless communication system 100 includes at least one WTRU 110 in wireless communication with a base station 150. The base station 150 may be in communication with a radio network controller (RNC) 120. Although not shown, additional WTRUs 110 may also exist in the wireless communication system 100 and be in communication with the base station 150.

FIG. 2 is a functional block diagram of the WTRU 110 in communication with the base station 150 where both are configured to transmit and receive data, respectively, in accordance with the present invention.

In addition to the components normally included in a typical WTRU, the WTRU 110 includes a processor 115 for preparing data for transmitting, a receiver 116 in communication with the processor 115, a transmitter 117 in communication with the processor 115, and an antenna 119 in communication with both the receiver 116 and the transmitter 117 to facilitate the transmission/reception of wireless data.

In addition to the components normally included in a typical base station, the base station 150 includes a processor 215 for processing data received from the WTRU 110, a receiver 216 in communication with the processor 215, a transmitter 217 in communication with the processor 215, and an antenna 219 in communication with both the receiver 216 and the transmitter 217 to facilitate the transmission/reception of wireless data.

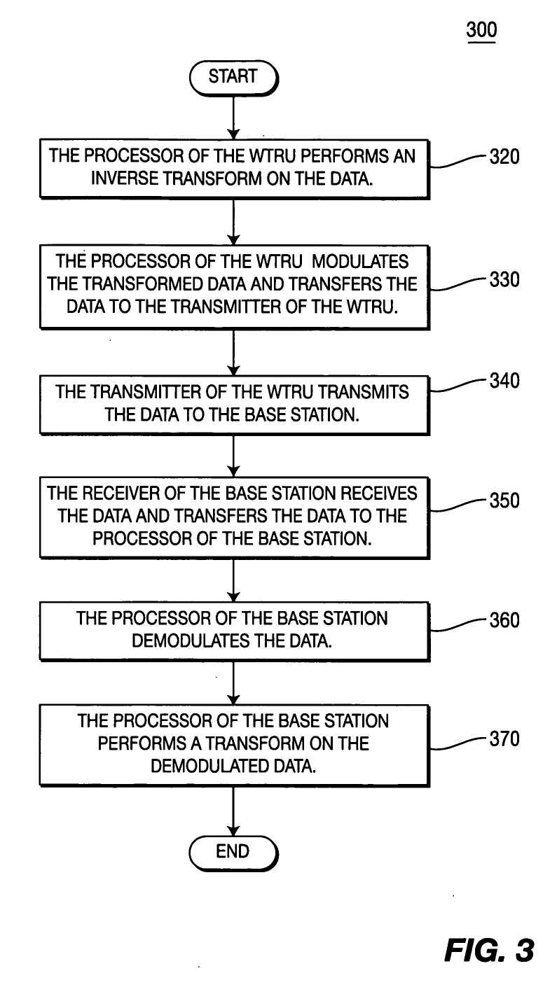

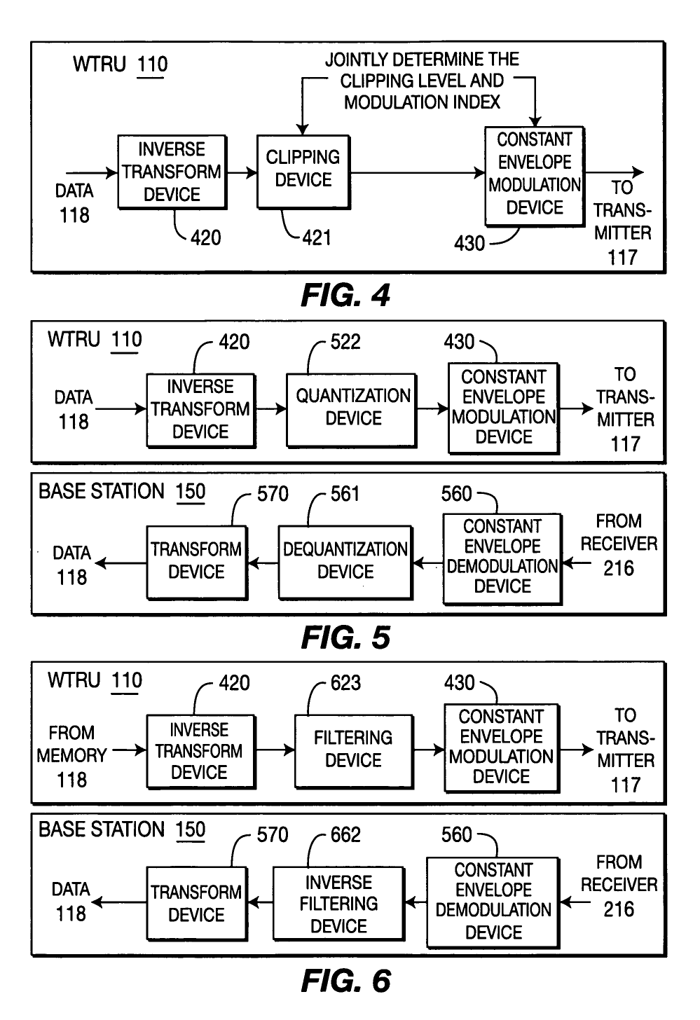

FIG. 3 is a flow diagram of a general process for transmitting and receiving data in the wireless communication system 100, in accordance with the present invention. The source of the data 118 (shown in FIG. 4) being acquired by the processor 115 may include a memory in the WTRU 110 or any other source for the data 118 known to one of ordinary skill in the art. Additionally, the data 118 may be processed through a serial to parallel converter prior to being received by the processor 115.

Once the processor 115 receives the data 118, the processor 115 performs an inverse transform operation on the data (step 320), which in a preferred embodiment is OFDM data. In a preferred embodiment of the present invention, the inverse transform may be an inverse discrete fourier transform (IDFT), an inverse discrete cosine transform (IDCT), or an inverse fast fourier transform (IFFT). However, other orthogonal transforms may be utilized in place of IDFT, IDCT, or IFFT. For example, an inverse lapped orthogonal transform (ILOT) or inverse extended lapped orthogonal transform (IELOT) may be utilized as the transforms performed by the processor 115. Whatever transform is used on the transmitter side should reduce variance of the output (for example some whitening transforms), and increase robustness and error correction/detection at the receiver.

In step 330, the processor 115 modulates the transformed OFDM data using CEM in a preferred embodiment, then transfers the CE-OFDM data to the transmitter 117 for wireless transmission to the base station 150. The CEM performed by the processor 115 in a preferred embodiment of the present invention is frequency modulation (FM), such as continuous phase frequency shift keying (CPFSK) or the like. This is to achieve a constant envelope transmitted signal to the base station 150.

Using CPFSK in place of continuous phase modulation (CPM), or phase modulation (PM), as is normally used in a CE-OFDM system, ensures that the data transmitted is not contained in phase and there is no phase wrapping problem (i.e. where the phase is out of the range of −π to π radians). Additionally, the use of FM allows for the CE-OFDM system to be a multi-carrier system instead of a single carrier system as is required by using phase modulation. The CE-OFDM data signal will ideally possess a 0 dB peak-to-average power ratio (PAPR) for transmission by the transmitter 117 of the WTRU 110.

Alternatively, if the transmitting WTRU 110 is not going to be a WTRU utilizing a CE-OFDM scheme, such as in an adaptive scheme which will be described below, then other modulation schemes such as CPM may be utilized. However, in a preferred embodiment of the present invention, CEM is utilized.

Once the transmitter 117 receives the CE-OFDM data signal, the transmitter 117 transmits the signal to the base station 150 through the antenna 119 (step 340).

The receiver 216 of the base station 150 receives the transmitted CE-OFDM data signal from the WTRU 110 via the antenna 219 and transfers the data signal to the processor 215 (step 350). The processor 215 then demodulates the CE-OFDM data signal using the corresponding modulation method that the data was modulated with by the processor 115 of the WTRU 110 (step 360). That is, if the WTRU 110 utilized CPFSK to modulate the data signal, then the processor utilizes the same type of modulation to demodulate the data.

Following demodulation (step 360), the processor 125 of the base station 150 performs a transform on the demodulated data (step 370). In a preferred embodiment, the transform corresponds to the inverse transform performed by the processor 115 of the WTRU 110.

Alternatively, it may be desirable for the processor 115 to post-process the data prior to step 330 where the data signal undergoes a constant envelope modulation (CEM). In this way, the data may be more suitably configured for further processing, such as the CEM, and transmission to the base station 150. The post-processing may encompass clipping the output of the inverse transformed data, quantization of the output of the transformed data, filtering of the output of the transformed data, or any combination of them.

FIG. 4 is a functional block diagram of a transmitting WTRU 110 employing clipping, in accordance with an alternative embodiment of the present invention. Among other components typical to a WTRU, the WTRU 110 of FIG. 4 includes an inverse transform device 420, a clipping device 421 and a CEM device 430. The inverse transform device 420 performs the inverse transform on the data 118, and the clipping device 421 clips the data prior to transfer to the CEM device 430. The CEM device 430 performs CE Modulation on the clipped data and transfers it to the transmitter 117. In this way, the variance of the data 118 undergoing CEM is reduced and the occupied bandwidth of the CE-OFDM system is reduced. Preferably, the clipping level should be jointly determined with a modulation index of the CEM to achieve a desired bit error rate (BER) and occupied bandwidth. Bandwidth reduction can thereby be effected by decreasing the modulation index, while simultaneously having the effect of reducing BER degradation.

For example, suppose an N-point inverse transform output sequence is denoted by Xₖ (k=0, 1, . . . , N-1), where k is the sample index and Yₖ denotes the results after clipping. An exemplary equation depicting a preferred clipping of the outputs with a clipping level A is:

$${Y}_{k} = \{ \begin{matrix}{X}_{k} & \vert {X}_{k} \vert \leq A \\ A \cdot exp \{ arg ( {X}_{k} ) \} & \vert {X}_{k} \vert > A\end{matrix} 0 \leq k \leq N - 1 \qquad Equation 1$$

That is, for any output sample Yₖ with an amplitude greater than A, its amplitude will be truncated to level A.

FIG. 5 is a functional block diagram of a transmitting WTRU 110 and receiving base station 150 employing quantization, in accordance with an alternative embodiment of the present invention. Among other typical WTRU components, the WTRU 110 of FIG. 5 includes an inverse transform device 420, a quantization device 522, a CEM device 430, and a transmitter 117. The inverse transform device 420 performs the inverse transform on the data 118, and the quantization device 522 quantizes the data prior to transfer to the CEM device 430. The CEM device 430 performs CE Modulation on the quantized data and transfers it to the transmitter 117. In a preferred embodiment of the present invention, the quantization is logarithm-based. However, the any quantization method known to one of ordinary skill in the art may be utilized.

Among other typical base station components, the base station 150 of FIG. 5 includes a CE demodulation device 560, a dequantization device 561, a transform device 570, and a receiver 216. The CE demodulation device 560 receives the data and transfers it to the CE demodulation device 560 for CE demodulation. After CE demodulation, the data is transferred to the dequantization device 561, which performs a corresponding dequantization on the data if the data was quantized by the transmitting WTRU 110. The dequantization, in a preferred embodiment, corresponds to the quantization performed on the data by the quantization device 522 of the WTRU 110. After dequantization, the data is transferred to the transform device 570, which performs a transform on the data corresponding to the inverse transform performed on the data by the inverse transform device 420 of the WTRU 110.

FIG. 6 is a functional block diagram of a transmitting WTRU 110 and receiving base station 150 employing filtering, in accordance with an alternative embodiment of the present invention. Among other typical WTRU components, the WTRU 110 of FIG. 6 includes an inverse transform device 420, a filtering device 623, a CEM device 430, and a transmitter 117. The inverse transform device 420 performs the inverse transform on the data 118, and the filtering device 623 filters the data prior to transfer to the CEM device 430. The CEM device 430 performs CE Modulation on the filtered data and transfers it to the transmitter 117. In a preferred embodiment of the present invention, the filtering includes multiplying a scrambling code, filtering, or preceding the output data from the inverse transform prior to CEM. Additionally, the filtering may incorporate fading channel effects to compensate for them.

Among other typical base station components, the base station 150 of FIG. 6 includes a CE demodulation device 560, an inverse filtering device 662, a transform device 570, and a receiver 216. The receiver 216 receives the data and transfers it to the CE demodulation device 560 for CE demodulation. After CE demodulation, the data is transferred to the inverse filtering device 662, which performs the corresponding inverse filtering (for example multiplying de-scrambling code, or inverse pre-coding) to the data. After inverse filtering, the data is transferred to the transform device 570, which performs a transform on the data corresponding to the inverse transform performed on the data by the inverse transform device 420 of the WTRU 110.

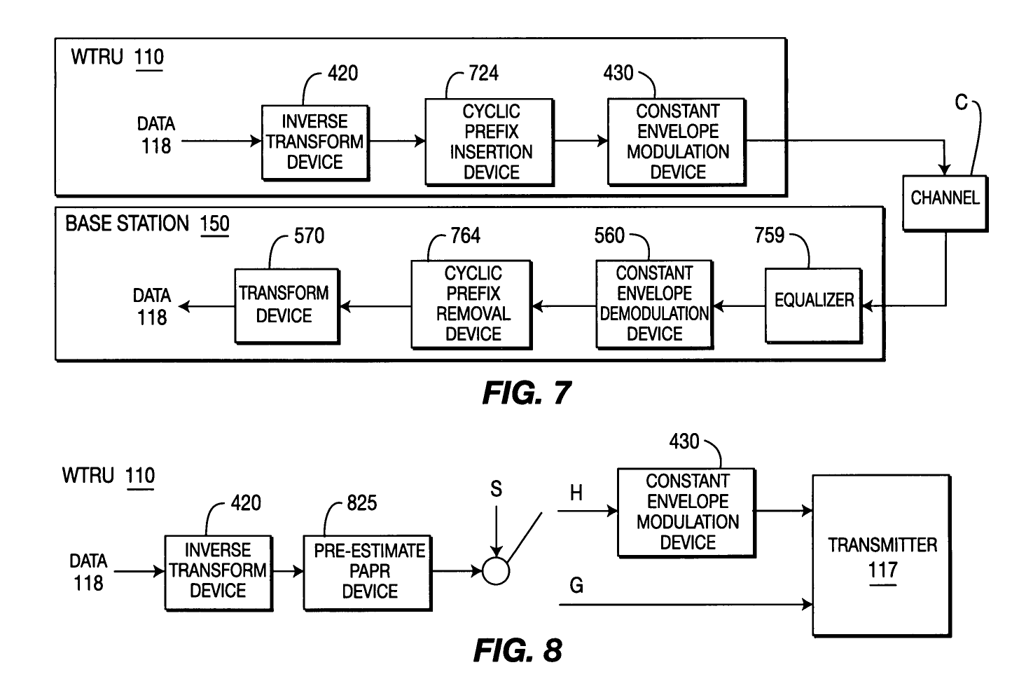

FIG. 7 is a functional block diagram of a transmitting WTRU 110 and receiving base station 150 utilizing a cyclic prefix, in accordance with an alternative embodiment of the present invention. Among other typical WTRU components, the WTRU 110 of FIG. 6 includes an inverse transform device 420, a cyclic prefix insertion device 724, and a CEM device 430. The inverse transform device 420 performs the inverse transform on the data 118, and the cyclic prefix insertion device 724 inserts a cyclic prefix into the data prior to transfer to the CEM device 430. The CEM device 430 performs CE Modulation on the filtered data and transfers it to the transmitter of the WTRU 110 (not shown), which transmits the data over a channel C.

Among other typical base station components, the base station 150 of FIG. 7 includes an equalizer 759, a CE demodulation device 560, a cyclic prefix removal device 764, and a transform device 570. A receiver in the base station (not shown) receives the data from the channel C, and transfers it to the equalizer 759. The equalizer 759 is utilized by the base station 150 where no guard period or cyclic prefix is inserted. In this case, the equalizer 759 should be robust, complicated and reliable capable of processing intersymbol interference (ISI) caused by not imparting a cyclic prefix or guard period.

The equalizer 759 transfers the data to the CE demodulation device 560 for CE demodulation. After CE demodulation, the data is transferred to the cyclic prefix removal device 764, which removes the cyclic prefix from the data prior to transferring it to the inverse transform device 420, which performs a transform on the data corresponding to the inverse transform performed on the data by the inverse transform device 420 of the WTRU 110.

FIG. 8 is a functional block diagram of a transmitting WTRU 110 employing an adaptive CE-OFDM scheme in accordance with another alternative of the present invention. Among other typical WTRU components, the WTRU 110 of FIG. 8 includes an inverse transform device 420, a pre-estimate PAPR device 825, a switch S, a CEM device 430, and a transmitter 117. The inverse transform device 420 performs the inverse transform on the data 118, and the pre-estimate PAPR device 825 estimates the PAPR. If the PAPR of the signal is determined to be above a pre-determined threshold, then the data signal is switched by the switch S to path H, where the signal will undergo CEM modulation by the CEM device 430 prior to transmission by the transmitter 117.

However, if the signal is determined to have a PAPR below the pre-determined threshold, then the signal is switched by the switch S to path G, where the signal is transmitted by the transmitter 117 without CEM. In a preferred embodiment of the present invention, the transmitting WTRU 110 may transmit a side signal to the receiving base station 150 to alert the receiving base station 150 whether or not CEM is applied.

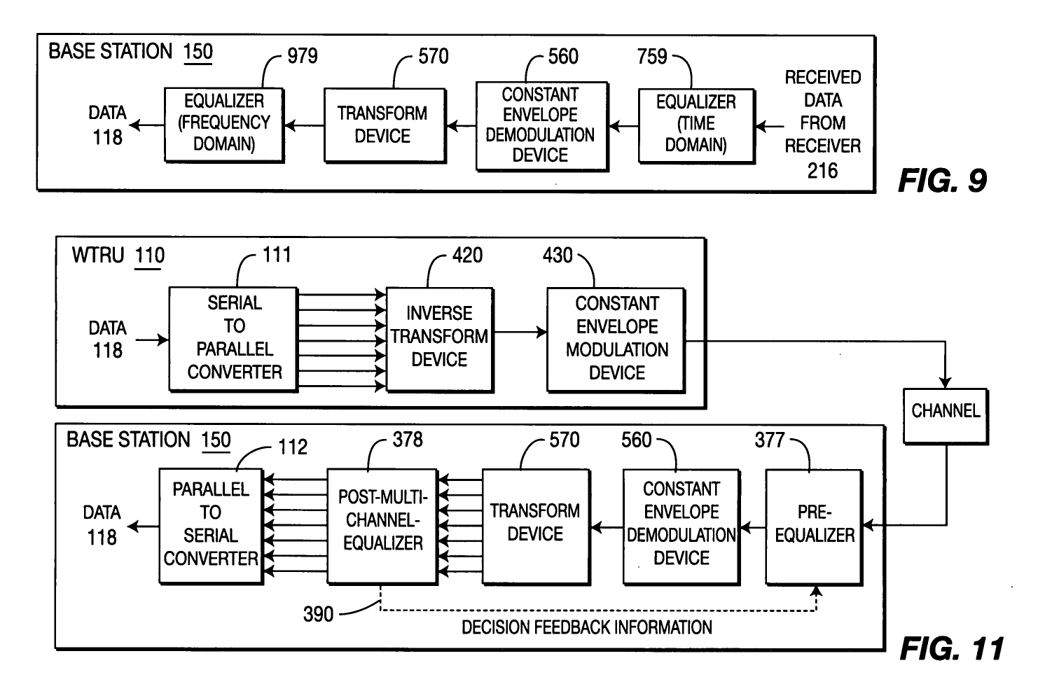

FIG. 9 is a functional block diagram depicting two stage equalization in the receiving base station 150, in accordance with the present invention. Among other typical base station components, the base station 150 of FIG. 9 includes an equalizer 759 (which is a time domain equalizer in a preferred embodiment), a CE demodulation device 560, a transform device 570, a frequency domain equalizer 979, and a receiver 216. The time domain equalizer 759 equalizes the data signal received from the receiver 216 in the time domain prior to the data signal undergoing constant envelope demodulation by the CE demodulation device 560. The CE demodulation device 560 then transfers the data to the transform device 570 which performs a transform on the data corresponding to any inverse transform performed by a transmitting device, such as WTRU 110.

The frequency domain equalizer 979 receives the data signal from the transform device 570 and equalizes the data signal in the frequency domain. This two stage equalization process possesses enhanced performance over a single stage equalization process. Furthermore, the complexity between the time domain equalizer 379 and the frequency domain equalizer 979 may be dynamically balanced with higher equalization complexity utilized at the time domain equalizer 759 until the time domain equalizer 759 enters steady state. Once that occurs, the equalization complexity at the time domain equalizer 759 may be decreased while the equalization complexity at the frequency domain equalizer 979 may be increased. Although the time domain equalizer 759 and the frequency domain equalizer 979 are shown in the receiving base station 150, alternatively either equalizer may be utilized in a transmitting WTRU 110.

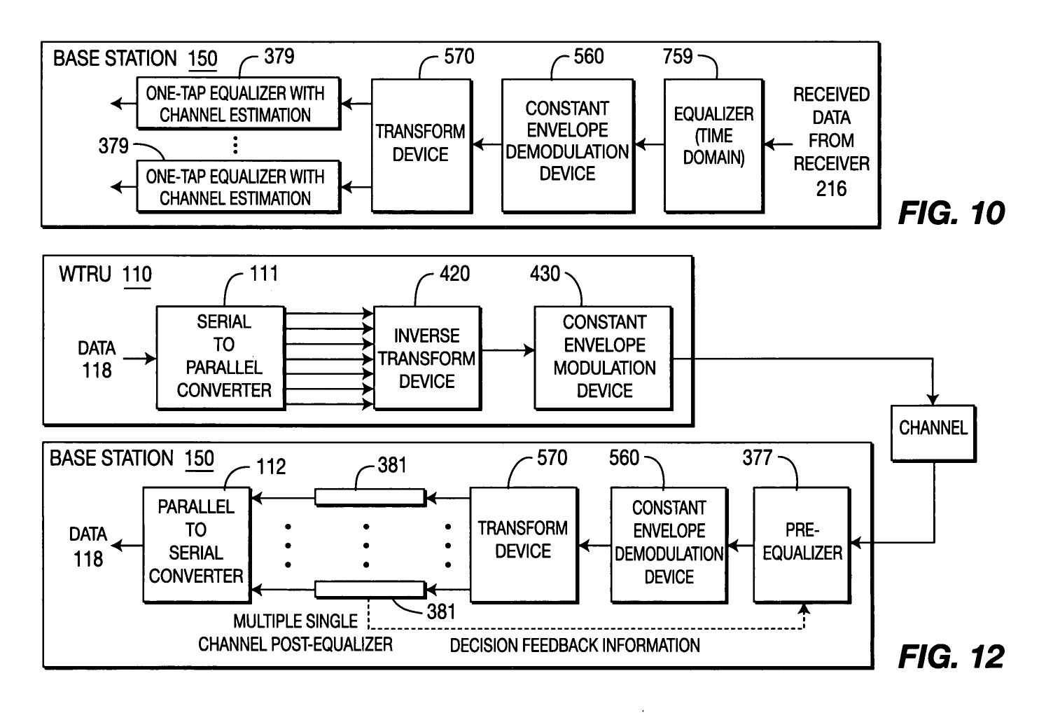

FIG. 10 is a functional block diagram depicting an alternative two stage equalization scheme in the receiving base station 150, in accordance with the present invention. Among other typical base station components, the base station 150 of FIG. 10 includes an equalizer 759 (which is a time domain equalizer in a preferred embodiment), a CE demodulation device 560, a transform device 570, a plurality of one-tap equalizers 379, and a receiver 216.

The time domain equalizer 759 equalizes the data signal received from the receiver 216 in the time domain prior to the data signal undergoing constant envelope demodulation by the CE demodulation device 560. The CE demodulation device 560 then transfers the data to the transform device 570 which performs a transform on the data corresponding to any inverse transform performed by a transmitting device, such as WTRU 110. The transform device 570 then transfers the data to the one-tap equalizers 379.

The one-tap equalizers 379 then perform channel estimation. Additionally, a first stage channel estimation may be performed prior to the CE-demodulation.

In a preferred embodiment, the one-tap equalizers 379 are parallel one-tap equalizers with channel estimation. The number of one-tap equalizers 379 should. be equal to the number of sub-carriers in the CE-OFDM system. The one-tap equalizers 379 may include a frequency domain equalizer (FDE), or a time domain equalizer (TDE), such as zero forcing (ZF), minimum mean square error (MMSE), and adaptive filters, such as those known to one of ordinary skill in the art.

Moreover, since the CE-OFDM system utilizes a constant envelope, blind time domain equalizers may be utilized as the one-tap equalizers 379. These equalizers utilize processes that acquire equalization through the processing of the transmitted data signal from the WTRU 110 instead of requiring a training signal such as a pilot signal known to the receiver, or base station 150. One particular process that may be utilized is constant modulus algorithm (CMA), which forces equalizer weights to maintain a constant envelope on the received data signal.

FIG. 11 is a functional block diagram of a transmitting WTRU 110 and a receiving base station 150 employing joint two-stage channel estimation with pre-equalization, in accordance with an alternative embodiment of the present invention.

Among typical WTRU components, the WTRU 110 of FIG. 11 includes a serial to parallel converter 111, an inverse transform device 420, and a CEM device 430. In a preferred embodiment of the present invention, the serial to parallel converter 111 is utilized by the WTRU 110 to convert the data 118 from serial to parallel prior to the inverse transform. The inverse transform device 420 then performs the inverse transform on the data prior to transfer to the CEM device 430. The CEM device 430 performs CE Modulation on the filtered data and transfers it to a transmitter of the WTRU 110 (not shown), which transmits the data over a channel.

Among typical base station components, the base station 150 of FIG. 11 includes a pre-equalizer 377, a CE demodulation device 560, a transform device 570, a post-multi channel equalizer 378, and a parallel to serial converter 112. The pre-equalizer 377 receives the data transmitted via the channel through a receiver (not shown), and equalizes the data signal received from the receiver in the time domain prior to the data signal undergoing constant envelope demodulation by the CE demodulation device 560.

The CE demodulation device 560 then transfers the data to the transform device 570 which performs a transform on the data corresponding to any inverse transform performed by the WTRU 110. The transform device then transfers the data to the post-multi channel equalizer 378, which performs equalization on the data signal after the data signal has been transformed. Accordingly, the post multi-channel equalizer 378 should equalize the multiple channels utilizing any algorithm known to one of ordinary skill in the art (for example least means squares (LMS), recursive least squares (RLS), or the like).

After post equalization by the post multi-channel equalizer 378, the equalized data is transferred to the parallel to serial converter 112. The post multi channel equalizer 378 may also provide decision feedback information 390 to the pre-equalizer 377 in order to enhance performance of both equalizers.

FIG. 12 is a functional block diagram of a transmitting WTRU 110 and a receiving base station 150 employing an alternative joint two-stage channel estimation, in accordance with the present invention. This alternative embodiment is substantially similar structurally and functionally to the embodiment of FIG. 11. However, the post multi channel equalizer 378 of FIG. 11 is replaced with a plurality of single channel post equalizers 381 in this embodiment. Each of the single channel post equalizers 381 provides decision feedback information 390 to the pre-equalizer 377 in order to enhance performance of both the pre-equalizer 377 and the single channel post equalizers 381.

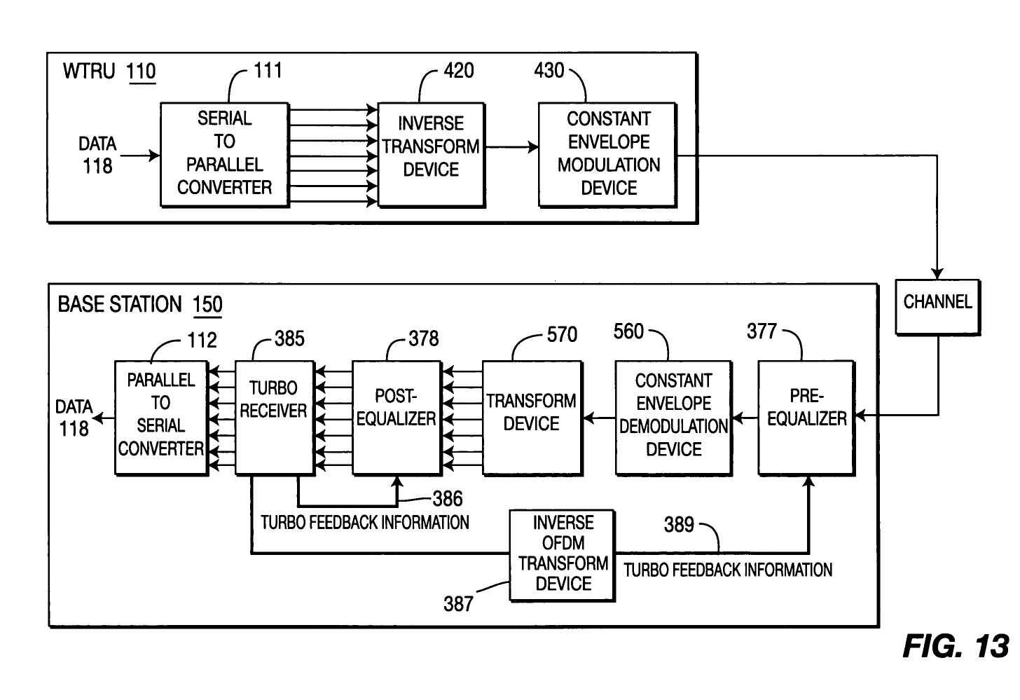

FIG. 13 is a functional block diagram of a transmitting WTRU 110 and a receiving base station 150 employing turbo equalization, in accordance with another alterative embodiment of the present invention.

Among typical WTRU components, the WTRU 110 of FIG. 13 includes a serial to parallel converter 111, an inverse transform device 420, and a CEM device 430. In a preferred embodiment of the present invention, the serial to parallel converter 111 is utilized by the WTRU 110 to convert the data 118 from serial to parallel prior to the inverse transform. The inverse transform device 420 then performs the inverse transform on the data prior to transfer to the CEM device 430. The CEM device 430 performs CE Modulation on the filtered data and transfers it to a transmitter of the WTRU 110 (not shown), which transmits the data over a channel.

Among typical base station components, the base station 150 of FIG. 13 includes a pre-equalizer 377, a CE demodulation device 560, a transform device 570, a post equalizer 378, a parallel to serial converter 112, and an inverse OFDM transform device 387. The post equalizer 378 is substantially similar to the multi channel post equalizer 378 of the embodiment in FIG. 11.

The pre-equalizer 377 receives the data transmitted via the channel through a receiver (not shown), and equalizes the data signal received from the receiver in the time domain prior to the data signal undergoing constant envelope demodulation by the CE demodulation device 560.

The CE demodulation device 560 then transfers the data to the transform device 570 which performs a transform on the data corresponding to any inverse transform performed by the WTRU 110. The transform device then transfers the data to the post-multi channel equalizer 378, which performs equalization on the data signal after the data signal has been transformed.

The post equalized data is directed into the turbo receiver 385, which provides turbo feedback information 386 to the post equalizer 378 to enhance performance of the post equalizer 378. The turbo receiver 385 transfers the post equalized data to the parallel to serial converter 112.

Additionally, the turbo receiver 385 transfers the equalized data to the inverse OFDM transform device 387, which performs an inverse OFDM transform on the equalized data in order to provide turbo feedback information (389) to the pre-equalizer 377 to enhance the performance of the pre-equalizer 377.

In a preferred embodiment of the present invention, the channel estimation may be performed iteratively as a two-stage channel estimation until pre-determined channel criteria are met. Any algorithm known to one of ordinary skill in the art may be utilized to perform the equalization operations.

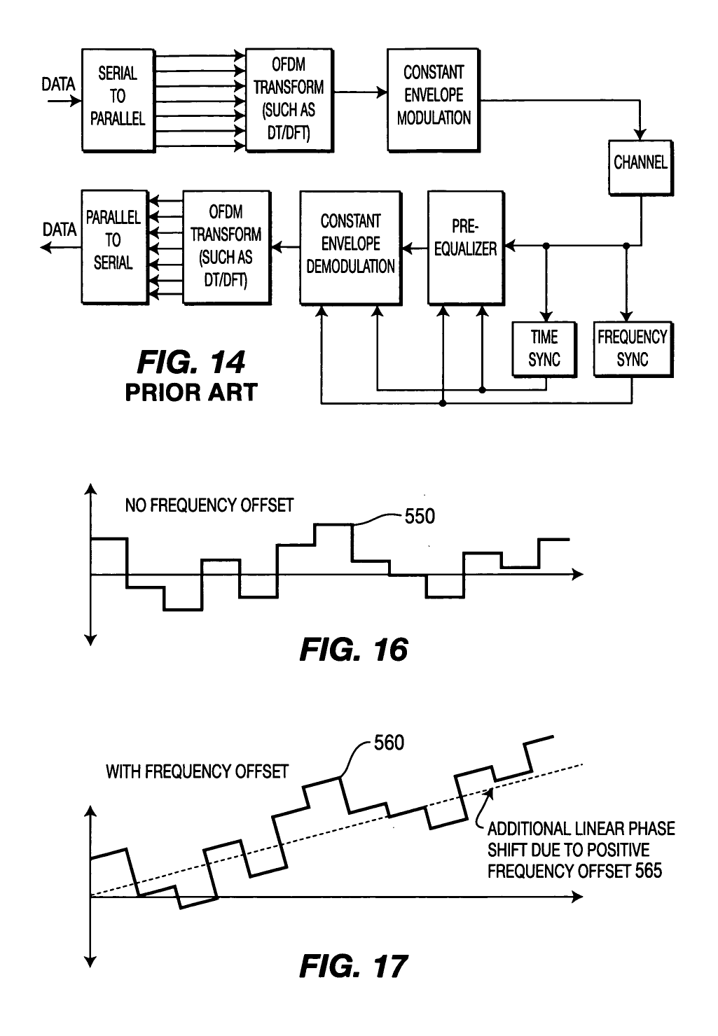

FIG. 14 is a functional block diagram of a prior art transmitting WTRU and a receiving WTRU. The received data signal is processed to achieve time and frequency synchronization, which is transferred to the pre-equalizer and CE demodulation functional blocks. The frequency synchronization block in the prior art may also attempt to correct for any frequency offset in the received data signal.

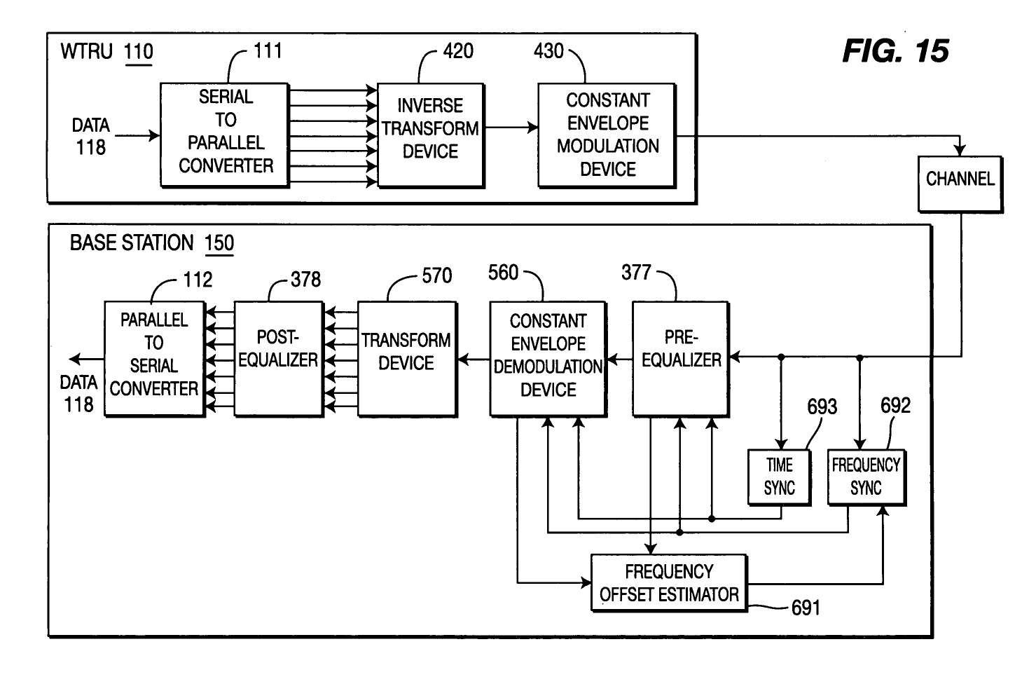

FIG. 15 is a functional block diagram of a transmitting WTRU 110 and a receiving base station 150 employing time and frequency synchronization, in accordance with an alternative embodiment of the present invention.

Among typical WTRU components, the WTRU 110 of FIG. 15 includes a serial to parallel converter 111, an inverse transform device 420, and a CEM device 430. In a preferred embodiment of the present invention, the serial to parallel converter 111 is utilized by the WTRU 110 to convert the data 118 from serial to parallel prior to the inverse transform. The inverse transform device 420 then performs the inverse transform on the data prior to transfer to the CEM device 430. The CEM device 430 performs CE Modulation on the filtered data and transfers it to a transmitter of the WTRU 110 (not shown), which transmits the data over a channel.

Among typical base station components, the base station 150 of FIG. 15 includes a pre-equalizer 377, a CE demodulation device 560, a transform device 570, a post equalizer 378, a parallel to serial converter 112, and a frequency offset estimator 691. The post equalizer 378 is substantially similar to the multi channel post equalizer 378 of the embodiment in FIG. 11.

In general, the pre-equalizer 377 receives the data transmitted via the channel through a receiver (not shown), and equalizes the data signal received from the receiver prior to the data signal undergoing constant envelope demodulation by the CE demodulation device 560.

The CE demodulation device 560 then transfers the data to the transform device 570 which performs a transform on the data corresponding to any inverse transform performed by the WTRU 110. The transform device then transfers the data to the post-multi channel equalizer 378, which performs equalization on the data signal after the data signal has been transformed. The post equalizer 378 then transfers the post equalized data to the parallel to serial converter 112.

The receiving base station 150 of FIG. 15 further utilizes the frequency offset estimator 691, which processes the demodulated signal from the pre-equalizer 377 and the CE demodulation device 560 in the phase domain to detect any frequency offset. The frequency offset estimator then provides the information to a frequency synchronization block 692, which provides information to the pre-equalizer 377 and the CE demodulation device 560. A time synchronization block 693 continues to also provide information to both the pre-equalizer 377 and the CE demodulation device 560. If a frequency offset exists, then the frequency offset will manifest itself as an additional linear component in the receive sequence of the detected/demodulated data signal.

FIG. 16 is a representation of a received signal 550 without frequency offset.

FIG. 17 is a representation of a received signal 560 with frequency offset. The frequency offset estimator block 691 has fit a the sequence of detected/demodulated data signal to a straight line and feeds the phase shift slope 565 back to the input to the frequency synchronization block 692 to control the receiver processor 215 clock frequency.

In an alternative embodiment of the present invention, an adaptive CE-OFDM scheme may be utilized which switches to and from an OFDM and a CE-OFDM transmission system depending on the path loss between the WTRU 110 and the base station 150 in the wireless communication system 100. For example, the WTRU 110 may transmit in CE-OFDM when transmitting at high power, such as when the path loss between the WTRU 110 and the base station 150 is large. Alternatively, the WTRU 110 may transmit in OFDM when transmitting at lower power levels, so as to optimize transmission according to the channel quality on different sub-carriers.

In one embodiment, the RNC 120 monitors the path loss of the WTRU 110 through the base station 150 and compares the path loss for the WTRU 110 to a predetermined threshold value stored in the RNC 120. For a WTRU 110 whose path loss is beneath the predetermined threshold value, the RNC 120 will signal to the WTRU 110 through the base station 150 to utilize OFDM transmission without CEM. To a WTRU 110 whose path loss value is greater than, or equal to, the predetermined threshold value, the RNC 120 will signal to the WTRU 110 through the base station 150 to utilize CE-OFDM transmission.

The separation between the WTRUs utilizing OFDM and the WTRUs utilizing CE-OFDM can be achieved in at least the following ways. The OFDM WTRUs and the CE-OFDM WTRUs may be time divided. That is, the period of use for OFDM WTRUs and CE-OFDMS WTRUs may be alternated. This alternation period may be fixed or may depend on the communication traffic. Alternatively, the separation may be achieved using a frequency division, where CE-OFDM WTRUs and OFDM WTRUs are allocated different frequencies along the spectrum. That is, the frequency spectrum may be divided between the two schemes according to the number of WTRUs on each scheme or the total amount of communication traffic on each scheme. The spectrum width may be adjusted using modulation indices or any other parameter relating to the modulation schemes known to one of ordinary skill in the art.

Another method may be for the RNC 120 to measure the path loss from each WTRU 110, and if none of the path losses are above the predetermined threshold value, the system will employ only one modulation scheme, such as OFDM. On the other hand, if at least one WTRU 110 has a path loss that exceeds the predetermined threshold value, then the wireless communication system 100 may switch to an alternative modulation scheme, such as CE-OFDM.

The methods described above may be implemented in a WTRU, a base station or AP configured as the network interface, within an air interface system, including but not limited to WCDMA, TDD, TDSCDMA, FDD, CDMA 2000, GSM, EDG, GPRS, CDMA, TDMA, and 802 wireless systems. The present invention applies to the following technologies: future system architecture, RRM and non-cellular. The present invention is applicable to the following wireless layers: Physical layer (L1).

Although the features and elements of the present invention are described in the preferred embodiments in particular combinations, each feature or element can be used alone (without the other features and elements of the preferred embodiments) or in various combinations with or without other features and elements of the present invention. For example, in a preferred embodiment of the present invention, the processing is performed by an application running on the processors of the WTRU or base station. For example, the features of the present invention may be incorporated into an integrated circuit (IC) or be configured in a circuit comprising a multitude of interconnecting components. Additionally, in a preferred embodiment of the present invention, the transmitting device is depicted as a WTRU and the receiving device is depicted as a base station. However, an additional WTRU may be employed as the receiving device in the place of the base station.

What is claimed is:

1. In a wireless communication system comprising at least one wireless transmit/receive unit (WTRU), a base station, and a radio network controller (RNC), a method for constant envelope orthogonal frequency division multiplexing (CE-OFDM) modulation, the method comprising:
the WTRU performing an inverse transform on data to be transmitted by the WTRU;
the WTRU performing CE modulation on the data and transmitting the CE-OFDM data to the base station;
the base station receiving the data and CE demodulating the data; and
the base station performing a transform on the demodulated data.

2. The method of claim 1, wherein the CE modulation is frequency modulation.

3. The method of claim 2, wherein the frequency modulation is continuous phase frequency shift keying modulation.

4. The method of claim 1, wherein the WTRU clips the data prior to performing CE modulation.

5. The method of claim 4 further comprising jointly determining the clipping level and the modulation index.

6. The method of claim 1, wherein the WTRU quantizes the data prior to performing CE modulation.

7. The method of claim 6, wherein the base station dequantizes the data after CE demodulating the data.

8. The method of claim 1, wherein the WTRU filters the data prior to performing CE modulation.

9. The method of claim 8 wherein the base station performs inverse filtering on the data after performing CE demodulation.

10. The method of claim 8 wherein the WTRU multiplies a scrambling code to the data prior to performing CE modulation.

11. The method of claim 10 wherein the base station multiplies a de-scrambling code to the data after performing CE demodulation.

12. The method of claim 8 wherein the WTRU precodes the data prior to performing CE modulation.

13. The method of claim 12 wherein the base station performs inverse precoding on the data after performing CE demodulation.

14. The method of claim 1, further comprising the WTRU inserting a cyclic prefix to the data prior to performing CE modulation.

15. The method of claim 14, further comprising the base station removing the cyclic prefix from the data after performing CE demodulation.

16. The method of claim 1, further comprising the base station equalizing the data prior to performing CE demodulation.

17. The method of claim 16 wherein the equalizing is time domain equalization.

18. The method of claim 16, further comprising the base station pre-equalizing the data after performing the transform on the demodulated data.

19. The method of claim 18 wherein the pre-equalization is frequency domain equalization.

20. The method of claim 1, further comprising converting the data from a serial data to parallel data prior to the WTRU performing the inverse transform.

21. The method of claim 20 further comprising converting the data from a parallel data to serial data after the base station transforms the data.

22. The method of claim 21, wherein the base station performs post-equalization to the data prior to the parallel to serial conversion, and the base station performs pre-equalization to the data prior to performing CE demodulation.

23. The method of claim 22, further comprising providing decision feedback information from the post-equalization to the pre-equalization step.

24. The method of claim 22, wherein the post equalization is performed by multiple single channel post-equalizers.

25. The method of claim 22, wherein the post-equalization is performed by a single post-multichannel equalizer.

26. The method of claim 22, further comprising providing turbo feedback information for post-equalization and pre-equalization.

27. The method of claim 26 further comprising performing an inverse OFDM transform on the post-equalized data.

28. The method of claim 22, further comprising estimating a frequency offset.

29. The method of claim 28, further comprising synchronizing time.

30. The method of claim 28, further comprising synchronizing frequency.

31. In a wireless communication system comprising at least one wireless transmit/receive unit (WTRU), a base station, and a radio network controller (RNC), a method for constant envelope orthogonal frequency division multiplexing (CE-OFDM) modulation, the method comprising:
performing an inverse transform on data to be transmitted by the WTRU;
pre-estimating the peak to average power ratio (PAPR); and
transmitting the data.

32. The method of claim 31, further comprising constant envelope modulating the data prior to transmitting the data, if the PAPR exceeds a pre-determined threshold.

33. In a wireless communication system comprising at least one wireless transmit/receive unit (WTRU), a base station, and a radio network controller (RNC), a method for constant envelope orthogonal frequency division multiplexing (CE-OFDM) modulation, the method comprising:
performing an inverse transform on data to be transmitted by the WTRU;
selecting a transmission system depending on a pathloss value between the WTRU and the base station; and
transmitting the data utilizing the selected transmission system.

34. The method of claim 33 wherein the transmission system implements at least one of CE-OFDM and OFDM.

35. The method of claim 34 wherein the pathloss between the WTRU and the base station equals or exceeds a predetermined threshold value and the selected transmission system is CE-OFDM.

36. The method of claim 35 wherein the RNC monitors the pathloss between the WTRU and the base station and transmits a signal to the WTRU through the base station for the WTRU to utilize CE-OFDM.

37. The method of claim 35 wherein all WTRUs in the wireless communication system utilize CE-OFDM.

38. The method of claim 34 wherein the pathloss between the WTRU and the base station is less than a predetermined threshold and the selected transmission system is OFDM.

39. The method of claim 38 wherein the RNC monitors the pathloss between the WTRU and the base station and transmits a signal to the WTRU through the base station for the WTRU to utilize OFDM.

40. The method of claim 38 wherein all WTRUs in the wireless communication system utilize OFDM.

41. The method of claim 34 wherein at least one WTRU utilizes CE-OFDM and at least one WTRU utilizes OFDM.

42. The method of claim 41 wherein the at least one WTRU utilizing CE-OFDM transmits on a different frequency than the at least one WTRU utilizing OFDM.

43. The method of claim 41 wherein the at least one WTRU utilizing CE-OFDM and the at least one WTRU utilizing OFDM transmit at different times.

44. A wireless transmit/receive unit (WTRU), comprising:
an inverse transform device;
a constant envelope modulation (CEM) device in communication with the inverse transform device; and
a transmitter in communication with the CEM device.

45. The WTRU of claim 44, further comprising a clipping device in communication with the inverse transform device and the CEM device.

46. The WTRU of claim 44, further comprising a quantization device in communication with the inverse transform device and the CEM device.

47. The WTRU of claim 44, further comprising a filtering device in communication with the inverse transform device and the CEM device.

48. The WTRU of claim 44, further comprising a cyclic prefix insertion device in communication with the inverse transform device and the CEM device.

49. The WTRU of claim 44, further comprising a pre-estimate PAPR device in communication with the inverse transform device and the CEM device.

50. The WTRU of claim 44, further comprising a pre-estimate PAPR device in communication with the inverse transform device and the transmitter.

51. The WTRU of claim 44, further comprising a serial to parallel converter in communication with the inverse transform device.

52. A base station comprising:
a receiver;
a constant envelope (CE) demodulation device in communication with the receiver; and
a transform device in communication with the CE demodulation device.

53. The base station of claim 52, further comprising a dequantization device in communication with the CE demodulation device and the transform device.

54. The base station of claim 52, further comprising an inverse filtering device in communication with the CE demodulation device and the transform device.

55. The base station of claim 52, further comprising a cyclic prefix removal device in communication with the CE demodulation device and the transform device.

56. The base station of claim 52, further comprising a pre-equalizer in communication with the receiver and the CE demodulation device.

57. The base station of claim 56 wherein the pre-equalizer is a time-domain equalizer.

58. The base station of claim 56, further comprising a post-equalizer in communication with the transform device.

59. The base station of claim 58 wherein the post-equalizer is a frequency domain equalizer.

60. The base station of claim 58 wherein the post-equalizer comprises a one-tap channel estimation equalizer.

61. The base station of claim 58 wherein the post-equalizer comprises a post-multi-channel equalizer.

62. The base station of claim 58 wherein the post-equalizer comprises at least one multiple single channel post-equalizer.

63. The base station of claim 58, further comprising a parallel to serial converter in communication with the post-equalizer.

64. The base station of claim 63, further comprising a turbo receiver in communication with the post-equalizer and the parallel to serial converter.

65. The base station of claim 64, further comprising an inverse transform device in communication with the turbo receiver and the pre-equalizer.

66. The base station of claim 58, further comprising a frequency offset estimator in communication with the CE demodulation device and the pre-equalizer.
